(19) United States
(12) Patent Application Publication
(10) Pub. No.: US 2026/0189137 A1
(43) Pub. Date: Jul. 2, 2026

(54) SWITCHING CIRCUIT ARRANGEMENT FOR POWER FACTOR CORRECTION

(71) Applicant: Inventronics GmbH, Garching b. München (DE)

(72) Inventors: Federico Rugger, Baierbrunn (DE); Filippo Branchetti, München (DE); Markus Heckmann, München (DE); Nitin Kumar, München (DE)

(21) Appl. No.: 19/125,089

(22) PCT Filed: Oct. 31, 2023
(86) PCT No.: PCT/EP2023/080327

§ 371 Date: Apr. 28, 2025

(30) Foreign Application Priority Data
Oct. 31, 2022 (DE) 10 2022 211 550.3

(51) Int. Cl. H02M 1/42; H02M 1/00; H02M 1/08; H02M 1/088; H02M 1/15

(52) U.S. Cl. CPC H02M 1/4241; H02M 1/0009; H02M 1/0058; H02M 1/083; H02M 1/088; H02M 1/15

(57) ABSTRACT

A switching circuit arrangement for power factor correction comprises a control unit, a first string which is connected to a first control output of the control unit, and at least one further string which is connected to a further control output of the control unit. Each of the strings contains a power factor correction element. Each of the power factor correction elements has a power input and a power output. The control unit is configured to output switching signals to the strings via the control outputs in such a way that the first string is controlled as a master string independently of the operation of the at least one further string, and the at least one further string is controlled as a slave string depending on the operation of the first string.

### CROSS REFERENCE TO RELATED APPLICATIONS

This application is a national phase filing under 35 U.S.C. § 371 of International Application No. PCT/EP2023/080327, filed Oct. 31, 2023, which claims the benefit of German Patent Application No. 10 2022 211 550.3, filed Oct. 31, 2022, the entire content of each of which is hereby incorporated by reference.

### TECHNICAL FIELD

The invention relates to a switching circuit arrangement for power factor correction.

### TECHNICAL BACKGROUND

Power factor correction (PFC) circuits serve to increase a power factor again, which is reduced by harmonics of the input current arising in non-linear circuits, in order thereby to reduce the load on the power grid.

Such circuits are used, for example, in dimmable LED luminaires and, generally, in SMPS-switched-mode power supplies.

Circuits for power factor correction, generally also referred to as power factor correction filters, are available, for example, as ASICs.

### SUMMARY OF THE INVENTION

It is therefore an object of the present invention to provide a switching circuit arrangement for power factor correction which can be easily adapted to a changed, in particular increased, power requirement.

The object is achieved by the subject matter of the independent claims. Further embodiments of the invention are specified in each case in the dependent claims. In this case, the subject matter of an independent claim may also be developed by features of the dependent claims of another independent claim.

The switching circuit arrangement according to the invention serves for power factor correction. It comprises a control unit, a first string which is connected to a first control output of the control unit, and at least one further string which is connected to a further control output of the control unit. Each of the strings contains a power factor correction element. Each of the power factor correction elements has a power input and a power output. The power inputs of the power factor correction elements are connected to a common power input. The power outputs of the power factor correction elements are connected to a common power output. The control unit is configured to output switching signals to the strings via the control outputs in such a way that the first string is controlled as a master string independently of the operation of the at least one further string, and the at least one further string is controlled as a slave string depending on the operation of the first string.

Control as a slave string means here that the operation of the corresponding string does not take place independently of the operation of the master string, but rather is influenced in some way by it, for example by setting a specific phase relationship to the operation of the master string or by setting a specific time duration or amplitude depending on the time duration or amplitude of the phase string.

Such a switching circuit arrangement which is constructed in a modular manner from two or more strings can be easily adapted, for example, to a changed, in particular to an increased, power requirement.

In an advantageous further embodiment, the control unit is formed as a microcontroller. As a result, for example, the control unit can be flexibly adapted to changed requirements, for example by changing the firmware.

In an advantageous further embodiment, each string furthermore contains a DC voltage converter for converting the level of the respective switching signal output by the control unit to a level suitable for switching the respective power factor correction element. As a result, for example, the switching circuit arrangement can be flexibly adapted to different embodiments of power factor correction elements.

In an advantageous further embodiment, the power factor correction element contains a choke and a power diode which are connected in series between a power input and a power output, and a switching element which is connected between a connection point between the choke and the power diode and ground. As a result, for example, an output voltage which is increased compared to the input voltage can be realized.

In an advantageous further embodiment, the power factor correction element furthermore contains a measuring device for detecting a point in time at which a choke current flowing through the choke has decayed to virtually zero, and for outputting a measuring signal at this point in time, wherein the measuring device is preferably configured to delay the outputting of the measuring signal to such an extent that a voltage-free switching of the switching element in the respective power factor correction element takes place. Furthermore, the control unit may contain a trigger input for receiving the measuring signal of a string and may be configured to trigger the switching signal to the respective string in response to the received measuring signal. As a result, for example, a transition mode can be realized in which a charging and discharging phase of the choke follow one another in each case without a pause, wherein the switching element is preferably protected by the voltage-free switching.

In an advantageous further embodiment, the at least one slave string furthermore contains a phase detector for detecting a phase difference between the switching signal output to the master string and the switching signal output to the slave string and for outputting a phase signal corresponding to the phase difference. Furthermore, the control unit may contain a phase signal input for receiving the phase signal of the corresponding string. As a result, for example, a regulation of the phase shift between the master string and the slave string can be realized.

In an advantageous further embodiment, the switching circuit arrangement additionally contains one or more further strings, wherein each of the further strings contains a power factor correction element and is connected to an output of the control unit assigned thereto, the power inputs of the further power factor correction elements are connected to the common power input, the power outputs of the further power factor correction elements are connected to the common power output, and the control unit is configured to control each of the further strings as a slave string. As a result, for example, the switching circuit arrangement can be flexibly adapted to increased powers.

In an advantageous further embodiment, the control unit is configured to output the switching signals of the slave strings in each case in a time-shifted manner with respect to a time profile of the switching signal of the master string with a time shift which is an integer multiple of the period duration of the switching signal of the master string divided by the total number of strings. As a result, for example, a low ripple current can be realized.

In an advantageous further embodiment, the control unit is configured to operate the master string and the at least one slave string in a transition mode. As a result, for example, a symmetrical operation of the strings can be realized.

In an advantageous further embodiment, the control unit is configured to lengthen or shorten the switch-on duration of the at least one slave string depending on a detected phase shift with respect to the switch-on duration of the switching signal of the master string. As a result, for example, an actuator for the regulation of the phase shift can be realized.

In an advantageous further embodiment, the control unit is configured to operate the master string in a transition mode and to operate the at least one slave string in a discontinuous mode. As a result, for example, an operation of the switching circuit arrangement can be realized for which a lower circuit complexity is required than for the transition mode.

In an advantageous further embodiment, the control unit is configured to shorten the switch-on duration of the at least one slave string with respect to the switch-on duration of the switching signal of the master string, wherein the control unit is preferably configured to set the switch-on duration of the at least one slave string such that a voltage-free switching of the switching element in the respective power factor correction element takes place. As a result, for example, a shortened charging and discharging phase of the choke and thus a pause between them can be realized, wherein the switching element is preferably protected by the voltage-free switching.

The method according to the invention serves for power factor correction using a switching circuit arrangement according to the invention. In this case, the control unit outputs the switching signals to the strings in such a way that the first string is controlled as a master string independently of the operation of the at least one further string, and the at least one further string is controlled as a slave string depending on the operation of the first string. By means of the method according to the invention, for example, the same effects can be achieved as by means of the switching circuit arrangement according to the invention.

### BRIEF DESCRIPTION OF DRAWINGS

Further features and expedients of the invention result from the description of an exemplary embodiment with reference to the attached drawings.

FIG. 1 shows a block diagram of a switching circuit arrangement for power factor correction according to an embodiment of the present invention.

FIG. 2 shows a simplified schematic circuit diagram of a power factor correction element contained in the switching circuit arrangement shown in FIG. 1.

FIG. 3 shows a time diagram of signals during operation of the switching circuit arrangement shown in FIG. 1 in a first operating mode.

FIG. 4 shows a diagram of the dependence of a period duration and a switch-off duration of switching signals shown in FIG. 3 with respect to time.

FIG. 5 shows a diagram of the dependence of a switching frequency of switching signals shown in FIG. 3 with respect to time.

FIG. 6 shows a time diagram of an inductor current with a changed switch-on duration.

FIG. 7 shows a block diagram of a function block for setting a changed switch-on duration depending on a detected phase shift.

FIG. 8 shows a time diagram of signals during operation of the switching circuit arrangement shown in FIG. 1 in a second operating mode.

### DETAILED DESCRIPTION

A switching circuit arrangement according to an embodiment of the present invention is described below with reference to the attached drawings.

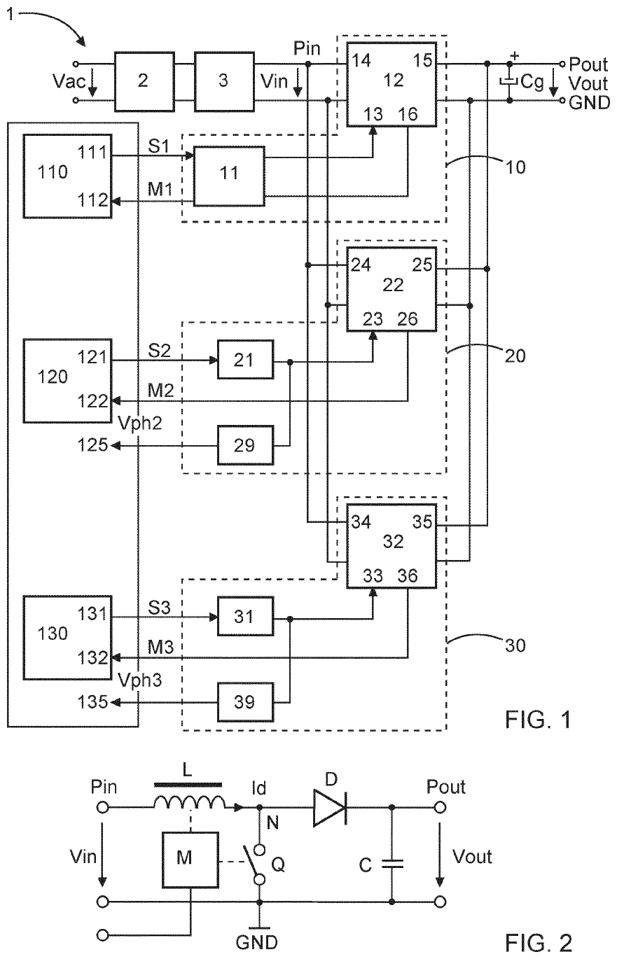

FIG. 1 shows a block diagram of a switching circuit arrangement 1. It contains an EMC mains filter 2 for damping the switching disturbances and a bridge rectifier 3 for full-wave rectification of the transformed alternating current.

For power factor correction, the switching circuit arrangement 1 comprises a first string 10, a second string 20, a third string 30 and a control unit 100 which serves for driving the three strings 10, 20, 30. The control unit 100 can be realized, for example, by a microcontroller whose mode of operation is defined by a dedicated firmware.

The control unit 100 contains three function blocks 110, 120, 130, each of which contains a control output 111, 121, 131 for outputting a control signal S1, S2, S3 to the respectively assigned string 10, 20, 30.

The three strings 10, 20, 30 have a common power input Pin whose input voltage Vin is the voltage which is output by the bridge rectifier 3 and which consists of successive sinusoidal half-waves, and a common power output Pout at which an output voltage Vout is output which can be used, for example, for operating a load (not shown).

Each of the three strings 10, 20, 30 is constructed in principle in the same manner and contains a DC voltage converter 11, 21, 31 and a power factor correction element 12, 22, 32. The control input 13, 23, 33 of each string is connected to the corresponding control output 111, 121, 131 of the control unit 100.

The DC voltage converters (DC-DC converters) can be designed, for example, as push-pull converters with a push-pull output stage.

Each power factor correction element 12, 22, 32 has a power input 14, 24, 34 and a power output 15, 25, 35. The power inputs 14, 24, 34 of the three strings 10, 20, 30 are connected to the common power input Pin. The power outputs 15, 25, 35 of the three strings 10, 20, 30 are connected to the common power output Pout.

The internal design of each of the power factor correction elements 12, 22, 32 substantially corresponds to a boost converter. A simplified schematic circuit diagram of such a power factor correction element is shown in FIG. 2.

The power factor correction element contains a choke L and a power diode D which are connected in series between the power input Pin and the power output Pout. Furthermore, the power factor correction element contains a switching element Q which is connected from a connection node N between the choke L and the power diode D to ground GND, and a charging capacitor C which is connected between the power output Pout and ground GND. In addition to or instead of the internal charging capacitors C, an external common charging capacitor Cg can also be connected between the common power output Pout and ground GND.

The switching element Q is designed to be electrically controllable, for example as a transistor which can be switched on or switched off by different levels of a control signal.

Optionally, the power factor correction element may furthermore contain a measuring device M for detecting a point in time at which a choke current Id flowing through the choke L has decayed to virtually zero when the switching element Q is switched off. Such a measuring device can be designed, for example, such that it monitors a voltage which is induced in a secondary winding fitted on the choke, or such that it monitors a voltage between the connection node N and ground GND or a voltage which is arising across the switching element Q and which experiences a dip when the choke current Id decays to virtually zero.

The output signal of the measuring device M is fed via a measuring output 16, 26, 36 of the respective power factor correction element 12, 22, 32 as a measuring signal M1, M2, M3 to a trigger input 112, 122, 132 of the corresponding function block 110, 120, 130 of the control unit 100.

Optionally, the second string 20 and the third string 30 may furthermore each contain a phase detector 29, 39 for detecting a phase shift between the switching signal S2, S3 output to the respective string and the switching signal S1 output to the first string 10. Such a phase detector may be formed, for example, in the form of a flip-flop which is set by a rise in the switching signal S1 and reset by a rise in the switching signal S2 or S3.

By averaging or low-pass filtering, it is possible to obtain from the output signal of the flip-flop an analog phase voltage Vph2, Vph3 which is fed to an ADC input 129, 139 of the control unit 100 and can be digitized by an analog-to-digital converter (not shown) contained in the control unit 100 and processed further by the control unit 100.

The control unit 100 is configured to output the switching signals S1, S2, S3 to the strings in such a way that the first string 10 is controlled as a master string independently of the operation of the second and third strings 20, 30, and such that the second and third strings 20, 30 are each controlled as slave strings depending on the operation of the first string 10. This may be effected in different ways.

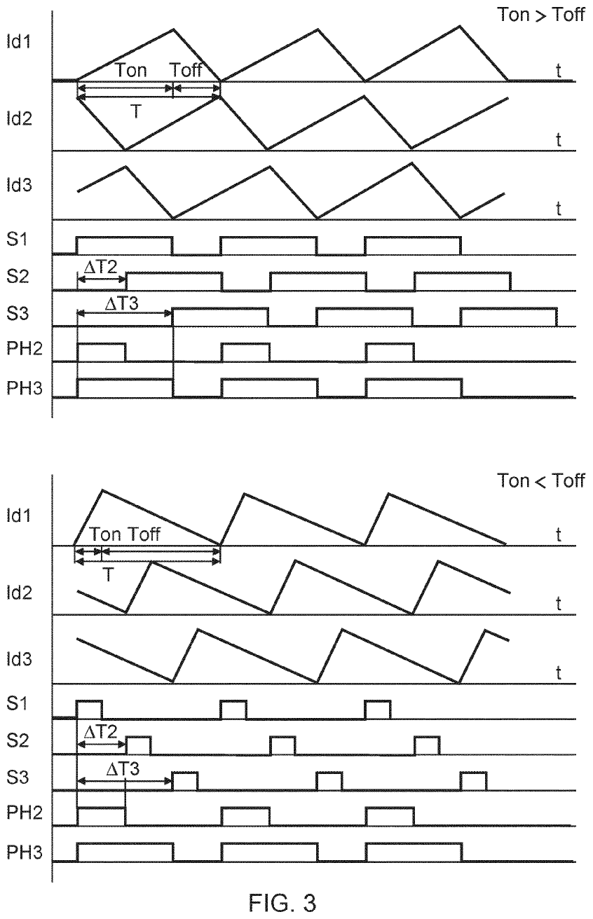

A first operating mode of the switching circuit arrangement 1 is described below with reference to FIG. 3. In this case, all strings 10, 20, 30 are operated in a transition mode in which the switching element Q contained in the power factor correction element 12, 22, 32 is periodically switched on and off.

When the switching element Q is switched on, the connection node N is connected to ground, and a choke current Id flowing through the choke L rises continuously. After the switching element Q has been switched off, the choke L discharges the energy stored in it via the power diode D into the charging capacitor C, wherein the choke current Id decreases continuously.

Transition mode means here that in each case a continuous transition takes place without a gap between the charging and discharging phase of the choke L, that is to say between the phases with rising or increasing choke current Id and with falling or decreasing choke current Id. This is realized, for example, by the switching element Q being switched on again precisely when the current flowing through the choke L has decreased to approximately zero. The transition mode could indeed also be realized by switching-on the switching element again earlier. However, such an operation would be less efficient than waiting for the complete discharge of the choke.

In order to operate the master string 10 in the transition mode, the control unit 100 outputs at the control output 110 a switching signal S1 which is, for example, at a high level (for example a level of 3 V customary for microcontrollers) for a predetermined switch-on period Ton and then decreases again to a low level (for example 0 V).

The switching signal S1 is converted by the DC voltage converter 11 to a level which is suitable for switching the switching element Q, for example to a high level of 15 V, and fed to the power factor correction element 12. As a result, the switching element Q contained therein is switched on and off in accordance with the switching signal S1.

The measuring device M contained in the power factor correction element detects the point in time at which the choke current Id has decayed to virtually zero when the switching element Q is switched off, and outputs the measuring signal M1 via the measuring output 16. The control unit 100 receives the measuring signal M1 via the trigger input 112 and sets the switching signal S1 again to a high level in response thereto. This sequence is repeated periodically.

After the choke current Id has decayed to virtually zero, an oscillation process occurs at the output of the switching element Q. This oscillation process depends on parasitic elements of the circuit such as, for example, an output capacitance of the switching element Q realized as a transistor and parasitic inductances of the lines. If the transistor remained switched off, the voltage arising across it would oscillate to and fro periodically between a minimum value, ideally zero or virtually zero, and a maximum value.

For the switching of the switching element Q, it is preferably waited until the voltage has decreased to zero or its minimum value. Switching at this time is referred to in the technical language as zero voltage switching (ZVS). Zero voltage switching is low-loss since, during switching, the product of current and voltage becomes zero. Quasi-resonant switching is a special form in order to achieve low-loss switching. The components L, D and Q from FIG. 2 have parasitic capacitances in practice. The inductance L and the parasitic capacitances result in a resonance which, after the demagnetization of L, leads to a reversal of the switching node. In the case of quasi-resonant switching, the point in time at which the voltage across Q reaches a minimum is used for switching-on Q again. If the condition Vout=2×Vin is met, the above-described reversal of the switching node makes it possible for the voltage across Q to become zero. The ZVS is reached completely at these operating points.

The measuring device M is therefore preferably configured to delay the outputting of the measuring signal M1 to such an extent that a voltage-free switching-on of the switching element Q is brought about by the switching signal S1 output by the control unit 100 in response to the receipt of the measuring signal M1.

A period duration T=Ton+Toff of the switching process thus results from the predefined switch-on duration Ton and a switch-off duration Toff which is determined by the discharge duration of the choke L. This in turn results from an instantaneous value of the input voltage Vin and the substantially constant output voltage Vout. Approximately the following applies:

$$Toff = {Ton}^{*} Vin / ( Vout - Vin )$$

The time durations are in this case selected such that a switching frequency fs resulting therefrom is substantially larger than a mains frequency fn of the rectified mains voltage, for example fs=10 KHz or more (period duration T=100 μs or less) at a mains frequency of 50 Hz. Thus 100 or more switching processes are dispensed with for a sinusoidal half-wave of the rectified mains voltage (duration 10 ms).

As can be seen from FIG. 3, in the present operating mode the slave strings 20, 30 are operated in the same way as the master string 10. However, the signal profile of the switching signal S2 is shifted with respect to the switching signal S1 by a time shift ΔT2, and the signal profile of the switching signal S3 is shifted by a time shift ΔT3. The time shifts are in this case ΔT2=⅓*T and ΔT3=⅔*T. The same time shifts result for the choke current Id2, Id3 of the slave strings 20, 30 with respect to the choke current Id1 of the master string 10.

As described above, the switch-off duration Toff, and thus the period duration T and the switching frequency fs, depend on the instantaneous value of the input voltage Vin and the output voltage Vout.

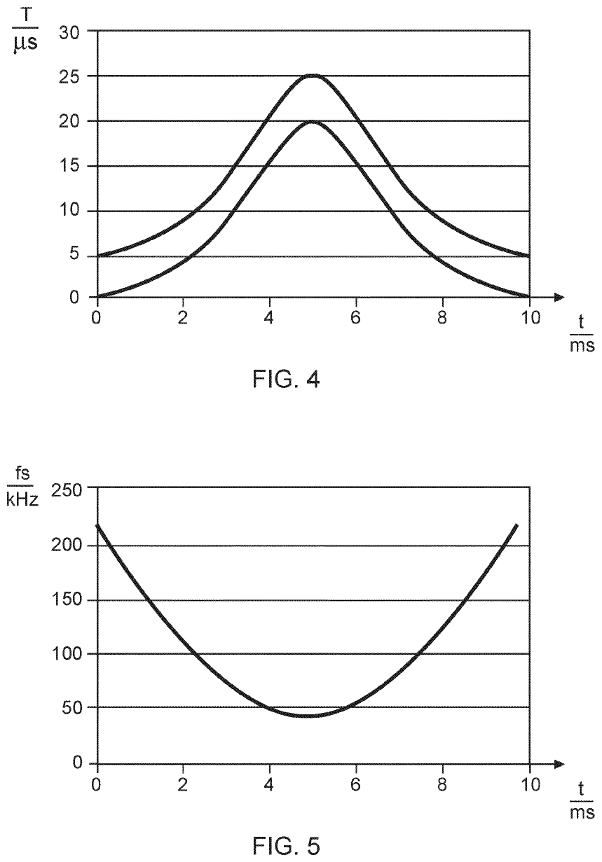

FIG. 4 shows an example of the dependence of the switch-off duration Toff and the period duration T with respect to time with a constant switch-on duration Ton, and FIG. 5 shows an example of the dependence of the switching frequency fs with respect to time. The example is based on the following values:

$$Mains voltage Vac = 230 Vac / 50 Hz$$

$$Input power = 160 W$$

$$Output voltage Vout = 400 Vdc$$

$$Choke inductance L = 760 mH$$

$$Switch - on duration Ton = 4.6 μ s$$

At an input voltage Vin of zero, the switch-off duration Toff is also zero, and at the peak value of the input voltage Vin (after 5 ms) it rises to approximately 20 μs. The period duration T therefore fluctuates approximately between 5 μs and 25 μs, and the switching frequency fs accordingly fluctuates approximately between 200 kHz and 40 KHz.

Since the period duration T of the switching signals S1, S2, S3 changes continuously, the time intervals ΔT2, ΔT3 between them may also not be fixedly predefined, but rather must be set dynamically. This takes place independently via a regulation with the aid of the phase detectors 29, 39.

In FIG. 3, phase signals PH2, PH3 generated internally in the phase detectors 29, 39 are shown before the low-pass filtering. If, at the transition of the input voltage Vin from zero to the peak point, the switch-off duration toff is increased and the period duration T rises as a result, with an unchanged time shift ΔT1, ΔT2, the averages of the phase signals PH1, PH2 and thus the phase voltages Vph2, Vph3 obtained by the low-pass filtering would fall, which is detected by the control unit 100. In order to delay the switch-on times of the switching signals S2, S3, the control unit 100 increases the switch-on duration Ton of the switching signals S2, S3 by a switch-on difference value ΔTon.

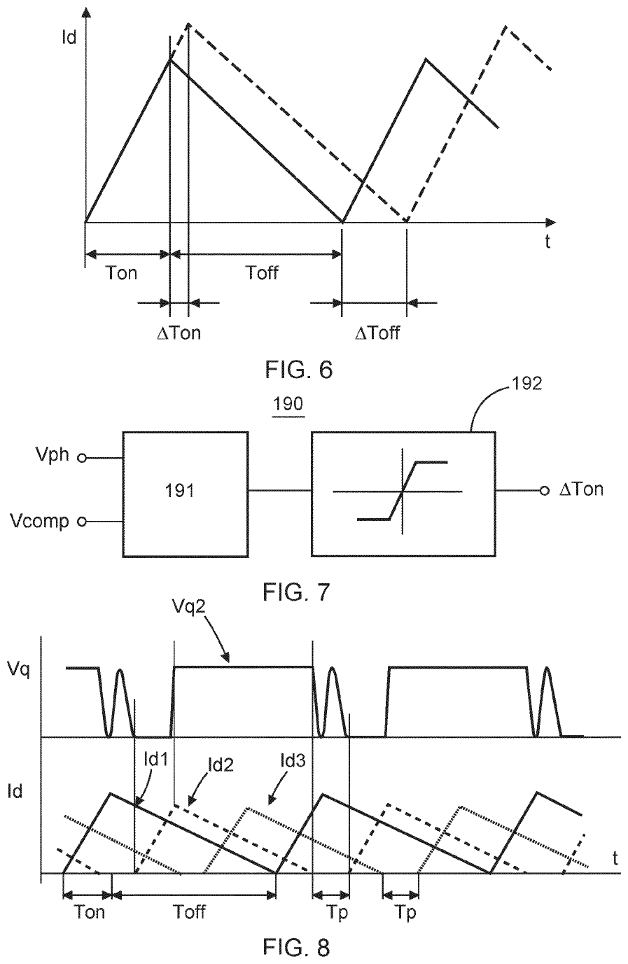

As shown in FIG. 6, the next switching-on of the respective switching element S is also delayed as a result, specifically by a switch-off difference value ΔToff, for which approximately the following applies:

$$Toff = {Ton}^{*} Vin / ( Vout - Vin )$$

As a result, the time shifts ΔT2, ΔT3 of the switching signals S2, S3 are increased with respect to the switching signal S1, as a result of which the deviations from a target sequence are reduced.

If, at the transition from the peak point to the zero crossing of Vin, the period duration T is reduced, the switch-on difference value ΔTon receives a negative sign, and the switch-on duration Ton is correspondingly shortened.

FIG. 7 shows a block diagram of a function block 190 for setting a changed switch-on duration ΔTon depending on a detected phase shift. The function block is preferably contained in the control unit 100 and is realized, for example, in the case of a configuration of the control unit 100 as a microprocessor by the firmware used.

In a comparison block 191, the phase voltage Vph (converted into a digital value) is compared with a comparison voltage Vcomp. Depending on the comparison result, the switch-on difference value ΔTon is set in a setting block. If the switch-on difference value ΔTon reaches a predefined maximum value, it is not increased further even in the case of an increasing control deviation Vph−Vcomp, but rather remains fixedly at its maximum value.

In order to meet the limit values, defined in the standard EN610003-2, for the harmonics of the mains input current, the maximum value for the switch-on difference value ΔTon must be very much smaller than the switch-on duration Ton. In the example described above with reference to FIGS. 3 and 4, the maximum value for ΔTon was defined at 0.9% of Ton.

Even if the slave strings 20, 30 are operated in principle just as independently as the master string 10, there is therefore a dependence of the operation of the slave strings 20, 30 on the master string 10 in that their phase relationship to the master string 10 is set by the regulation described above.

A second operating mode of the switching circuit arrangement 1 is described below with reference to FIG. 8. In this case, too, the master string 10 is controlled by the control unit 100 as described above in such a way that it is operated in the transition mode. However, departing from the above, the slave strings 20, 30 are controlled in such a way that they are operated in a discontinuous mode.

In the discontinuous mode, too, the switching element Q contained in the power factor correction element 22, 32 is periodically switched on and off. Unlike in the transition mode, however, the charging phase with rising choke current Id does not immediately follow the discharging phase with falling choke current Id, but rather only after a time interval with a pause duration Tp.

This is realized, for example, in that the switch-on duration Ton of the slave strings 20, 30 is made smaller than the switch-on duration Ton of the master string 10. Preferably, the switch-on duration Ton of the slave strings 20, 30 is made smaller by 5 to 30% in comparison to the switch-on duration Ton of the master string 10. As can be seen from FIG. 8, the choke current Id in the slave strings 20, 30 therefore also rises only up to a smaller peak value than in the master string 10. This results in a smaller discharge duration for the choke L.

On the other hand, the period duration T remains the same for all three strings 10, 20, 30. Therefore, in the slave strings 20, 30, the discharge duration of the choke L is followed by a pause until the switching element Q is switched on again again, during which pause the choke current Id remains at zero apart from smaller oscillations.

In this operating mode, the times of the switch-on again therefore do not result from the operation of the slave strings 20, 30 themselves, but rather are specified centrally by the control unit 100 depending on the time profile of the master string 10 in such a way that they are temporally shifted with respect to one another in each case by T/3 in the three strings 10, 20, 30.

In this case, the slave strings are oriented for the period duration T on the master string and, depending on the operating mode, are either likewise operated in the transition mode or preferably in the discontinuous mode, wherein the switch-on times Ton are shortened with respect to the master string. The phenomenon of self-synchronization and phase matching of a plurality of adjacent free-oscillating systems is prevented by the avoidance of a real free-oscillating operation of the slave strings. The quasi-resonant low-loss operation is achieved for the slave strings by the shortening of the Ton times being selected such that the switch-on times thereof meet a voltage minimum at the switching element. Here too, a complete ZVS is achieved if Vout≥2×Vin is met.

As explained above in the description of the transition mode, an oscillation process occurs at the output of the switching element Q after the choke current Id has decayed to virtually zero. FIG. 8 shows, as an example, the voltage Vq2 arising across the switching element Q of the second string 20.

Since the switch-on times of the switching elements Q of the three power factor correction elements 12, 22, 32 are fixedly predefined by the control unit 100 in the discontinuous mode, a voltage-free switching of the slave strings 20, 30 is realized in this case by a suitable setting of the shortened switch-on durations Ton.

In contrast to the transition mode, in which the switching-on of the switching element Q takes place when the first minimum is reached, in the discontinuous mode, as shown in FIG. 8 using the example of Vq2, a wait is made for the second minimum to be reached. Theoretically, it would also be possible to wait for the third minimum or a later minimum to be reached. However, this would always further reduce the efficiency of the switching circuit arrangement.

The period duration of the oscillation at the switching element Q depends on the parasitic elements of the three power factor correction elements 12, 22, 32 and is therefore independent of the switching frequency fs currently being used. The period duration can be determined, for example, by measurement. Depending thereon, the switch-on durations Ton of the slave strings 20, 30 can be set by the control unit 100 depending on the instantaneous switching frequency fs such that the voltage Vq arising across the switching element Q reaches its second minimum for a period duration after the switching-on of the switching element Q, such that a voltage-free switching of the switching element Q takes place.

The pause duration Tp resulting therefrom is approximately between 10 and 30% of the period duration T.

This switching scheme may be discussed on the basis of an exemplary calculation. As already explained above, Ton and Toff denote the switch-on and switch-off durations of the master string. The choke or inductor current is indicated in FIG. 8 by Id 1; it can be readily seen that it does not gap. In the time Ton, the choke is magnetized, and in the time Toff is demagnetized. The next magnetization then follows without a pause. If the choke currents Id 2 and Id 3 in FIG. 8 are considered, it can be clearly seen that the magnetization time, which is to be called Ton_s below, is shorter. This also leads to a shorter demagnetization time since the peak current, which can likewise be readily seen in the diagram of FIG. 8, is lower. A gap Tp therefore arises, in which the switching element is likewise switched off. In the voltage profile Vq2 of FIG. 8, which shows the voltage across the switching element of the slave string with the corresponding choke current Id 2, it can be readily seen that there is an oscillation after the complete demagnetization of the choke. The control of the switching element Q must now take place such that the switch-on time falls into a voltage minimum in order to enable low-loss switching.

The switch-on duration of the switching element Q of the slave string necessary for this can be calculated as follows:

$$Ton\_s = Ton - Tskip * \frac{Vout - Vin}{Vout} ;$$

wherein Vout is the supply voltage of the strings, that is to say the output voltage of the power factor correction element 22, 32, and the voltage Vin is the input voltage of the power factor correction element 22, 32. Tskip is the time duration between two minima of the voltage Vq across the switching element Q and is therefore shorter by approximately the factor 1.5 than the time duration Tp from FIG. 8. Tskip may be calculated from the Thomson oscillation equation (https://de.wikipedia.org/wiki/Thomson oscillation equation), wherein L is the converter inductance L, and C is the sum of the capacitances at the switching node. The control unit 100 calculates the individual switch-on durations Ton_s for the slave strings 20, 30 accordingly. Alternatively, the values may of course also be defined in table form or in the form of a characteristic map, and the corresponding values can be read out in accordance with the boundary conditions. This has the advantage that the control unit 100 has to provide less computing power and parasitic effects which are difficult to establish in formulae can be included in the tables or characteristic maps.

A correspondingly controlled switching element Q thus switches on at a voltage minimum and enables quasi-resonant, low-loss switching.

The following effects can be achieved with the above-described switching circuit arrangement and its different operating modes:

The modular design of three strings and a common control unit enables great flexibility for covering a broad power range. The realization of the control unit by a microcontroller and dedicated firmware increases the flexibility compared to the ASICs used hitherto which have hitherto only been present for the transition mode and can drive a maximum of two power strings.

The division of the power between three strings makes it possible to use smaller components, as a result of which weight and costs can be saved. As a result of the uniform phase shift between the three branches, it can be achieved that the resulting overall current has the smallest possible ripple component.

During operation in the transition mode, the regulation of the phase shift may also prevent self-synchronization of the strings which otherwise possibly takes place as a result of coupling between the strings.

Since the switch-on times of the switching elements Q are fixedly predefined by the control unit in the discontinuous mode, neither the measuring devices contained in the power factor correction elements nor the phase detectors are required in the slave strings. As a result, the circuit design can be simplified.

Furthermore, during operation in the discontinuous mode, no external triggering of the slave strings is required. As a result of the saving of a retrigger circuit in each slave string, the switching circuit arrangement can be further simplified.

The switching circuit arrangement is not restricted to the example shown above with three strings. Instead, it may also contain only two strings, a master string and a slave string. Alternatively, it may also contain four or more strings. Instead of an integer multiple of ⅓, an integer multiple of 1/n is then selected in each case as the phase shift ΔT/T between the switching signals of the individual strings, where n is the total number of strings.

As a result, the switching circuit arrangement can be scaled and can be easily adapted to higher powers. As a result of the uniform distribution of the switching signals, a low ripple current can also be achieved here.

### LIST OF REFERENCE NUMERALS

Switching circuit arrangement 1
EMC mains filter 2
bridge rectifier 3
master string 10
slave strings 20, 30
DC voltage converters 11, 21, 31
power factor correction elements 12, 22, 32
control input 13, 23, 33
power input 14, 24, 34
power output 15, 25, 35
measuring output 16, 26, 36
phase detector 29, 39
control unit 100
function block 110, 120, 130
control output 111, 121, 131
trigger input 112, 122, 132
ADC input 125, 135
function block 190
comparison block 191
setting block 192
charging capacitor C
common charging capacitor Cg
power diode D
mains frequency fn
switching frequency fs
ground GND
inductor current Id
choke L
Measuring device M
Measuring signal M1, M2, M3
Connection node N
common power input Pin
common power output Pout
switching element Q
Switching signal S1, S2, S3
Phase signal PH2, PH3
Period duration T
Switch-off duration Toff
Switch-on duration Ton
Switch-on duration of a slave string Ton_s
Pause duration Tp
Pause duration between two voltage minima Tskip
AC mains voltage Vac
comparison voltage Vcomp
input voltage Vin
output voltage Vout
phase voltage Vph2, Vph3
voltage arising across the switching element Vq
time shift ΔT2, ΔT3
switch-on difference value ΔTon
switch-off difference value Δtoff

1. A switching circuit arrangement for power factor correction, comprising:
a control unit,
a first string which is connected to a first control output of the control unit, and
at least one further string which is connected to a further control output of the control unit,
wherein each of the strings contains a power factor correction element,
each of the power factor correction elements has a power input and a power output,
the power inputs of the power factor correction elements are connected to a common power input,
the power outputs of the power factor correction elements are connected to a common power output,
the control unit is configured to output switching signals to the strings via the control outputs in such a way that the first string is controlled as a master string independently of operation of the at least one further string, and the at least one further is controlled as a slave string depending on operation of the first string,
wherein
the control is configured to operate the master string in a transition mode and to operate the at least one slave string either in a transition mode or in a discontinuous mode, and to shorten a switch-on duration of the at least one slave string with respect to a switch-on duration of the master string.

2. The switching circuit arrangement according to claim 1, wherein the control unit is formed as a microcontroller.

3. The switching circuit arrangement according to claim 1, wherein each string furthermore contains a DC voltage converter for converting a level of the respective switching signal output by the control unit to a level suitable for switching the respective power factor correction element.

4. The switching circuit arrangement according to claim 1, wherein the power factor correction element contains:
a choke and a power diode which are connected in series between the power input and the power output, and
a switching element which is connected between a connection point between the choke and the power diode and ground.

5. The switching circuit arrangement according to claim 4, wherein the power factor correction element furthermore contains a measuring device for detecting a point in time at which a choke current flowing through the choke has decayed to virtually zero, and for outputting a measuring signal.

6. The switching circuit arrangement according to claim 5, wherein
the control unit furthermore contains a trigger input for receiving the measuring signal of a string, and
the control unit is configured to trigger the switching signal to the respective string in response to the received measuring signal.

7. The switching circuit arrangement according to claim 1, wherein
the at least one slave string furthermore contains a phase detector for detecting a phase difference between the switching signal output to the master string and the switching signal output to the slave string and for outputting a phase signal corresponding to the phase difference.

8. The switching circuit arrangement according to claim 7, wherein the control unit furthermore contains a phase signal input for receiving the phase signal of the slave string.

9. The switching circuit arrangement according to claim 1, which furthermore additionally contains one or more further strings, wherein each of the further strings contains a power factor correction element and is connected to a control output of the control unit assigned thereto,
the power inputs of the further power factor correction elements are connected to the common power input,
the power outputs of the further power factor correction elements are connected to the common power output, and
the control unit is configured to control each of the further strings as a slave string.

10. The switching circuit arrangement according to claim 1, wherein the control unit is configured to output the switching signals of the slave strings in each case in a time-shifted manner with respect to a time profile of the switching signal of the master string with a time shift which is an integer multiple of a period duration of the switching signal of the master string divided by a total number of strings.

11. The switching circuit arrangement according to claim 1, wherein the control unit is configured to lengthen or shorten the switch-on duration of the at least one slave string depending on a detected phase shift with respect to the switch-on duration of the master string.

12. The switching circuit arrangement according to claim 1, characterized in that a period duration of oscillation at a switching element depends on parasitic elements of the power factor correction elements and is thus independent of a switching frequency currently being used.

13. (canceled)

14. The switching circuit arrangement according to claim 1, wherein the control unit is preferably configured to set the switch-on duration of the at least one slave string such that a quasi-resonant low-loss switching of a switching element in the respective power factor correction element takes place, wherein the switch-on duration of the at least one slave string is shorter than the switch-on duration of the master string.

15. The switching circuit arrangement according to claim 5, wherein the measuring device is preferably configured to delay the outputting of the measuring signal to such an extent that a voltage-free switching of the switching element in the respective power factor correction element takes place.

16. A method for power factor correction using a switching circuit arrangement, the method comprising:
outputting, with a control unit, switching signals to strings via control outputs of the control unit in such a way that a first string is controlled as a master string independently of operation of at least one further string, and the at least one further string is controlled as a slave string depending on operation of the first string,
wherein the first string is connected to a first control output of the control unit, and the at least one further string is connected to a further control output of the control unit,
wherein each of the strings contains a power factor correction element,
each of the power factor correction elements has a power input and a power output,
the power inputs of the power factor correction elements are connected to a common power input,
the power outputs of the power factor correction elements connected to a common power output;
operating, with the control unit, the master string in a transition mode and the at least one slave string either in a transition mode or in a discontinuous mode; and
shortening, with the control unit, a switch-on duration of the at least one slave string with respect to a switch-on duration of the master string.
